(19) United States
(12) Patent Application Publication
(10) Pub. No.: US 2003/0172186 A1
(43) Pub. Date: Sep. 11, 2003

(54) Method, system and program product for transcoding content

(75) Inventors: C. Eric Dunn, Round Rock, TX (US); Teng Hu, Austin, TX (US); Mansoor Lakhdhir, Austin, TX (US)

Correspondence Address: HOFFMAN WARNICK & D'ALESSANDRO, LLC, 3 E-COMM SQUARE, ALBANY, NY, 12207

(73) Assignee: INTERNATIONAL BUSINESS MACHINES COPORATION, ARMONK, NY

(21) Appl. No.: 10/093,441

(22) Filed: Mar. 7, 2002

(51) Int. Cl. G06F 15/16

(52) U.S. Cl. 709/246

(57) ABSTRACT

The present invention provides a method, system and program product for transcoding content. Specifically, under the present invention, selected content is retrieved from a content source to a server. Once retrieved, the content is transcoded into a format used by a remote device. The transcoded data could then be tested for accuracy and stored in an external file system. Once stored, a mobile Internet agent will route the content from the file system to the remote device.

### BACKGROUND OF THE INVENTION

1. Field of the Invention

The present invention generally provides a method, system and program product for transcoding legacy content. Specifically, the present invention allows selected content to be efficiently retrieved from a storage system, transcoded and delivered to a mobile device by a mobile internet service provider.

2. Background Art

As the use of mobile/remote (e.g., wireless) devices such as personal digital assistants, cellular phones, etc., becomes more prolific, the demand for Internet access through such devices increases. Accordingly, various mobile Internet service providers such as AvantGo® have been formed for delivering content and applications to the remote device users. Problems arise, however, when the content has to be transcoded from a first format to a second format. For example, a news article posted on a website may contain graphics or other elements that a hand-held device is not capable of displaying. Thus, the graphics may have to be compressed or clipped from the content for delivery to the hand-held devices.

Heretofore, attempts have been made to provide accurate content to remote devices. Such attempts, however, generally rely on the manual transcoding of the content between formats. That is, a technical editor is required to copy, paste, modify the content, and then publish the content (e.g, using the “ftp” command). Such manualization results in a high volume of errors in the content.

Computerized systems that have been developed for publishing web content for users fail to provide a way for content to be transcoded and routed to a remote, external destination. Rather, the systems generally rely on publication to a full-scale computer system. Moreover, many existing systems provide the content in an intermediate format for viewing by users. As such, existing systems fail to provide the content to remote device in the “native” format employed by the remote device. In addition, existing systems fail to provide a way to test transcoded content to ensure that it is accurate and readable by the remote device.

In view of the foregoing, there exists a need for a method, system and program product for transcoding legacy content. A further need exists for such a method, system and program product that allows for content to be selected via an interface. Still yet, a need exists for a method, system and program product in which selected content is retrieved from a content source and transcoded into a format used by a remote device. Another need exists for a method, system and program product in which transcoded content can be tested for accuracy. A further need exists for a method, system and program product that can store transcoded content in an external file system where a mobile Internet agent will route the content to a remote device.

### SUMMARY OF THE INVENTION

The present invention provides a method, system and program product for transcoding content. Specifically, under the present invention, content selected via an interface is retrieved from a content source to a server. Once retrieved, the content is automatically (i.e., not manually) transcoded into a format used by a mobile Internet service provider for delivery to a remote device. The transcoded content could then be tested and stored in a file system external to the server. A mobile Internet agent will then route the stored content from the file system to a remote device.

According to a first aspect of the present invention, a method for transcoding content is provided. The method comprises the steps of: (1) selecting content using an interface; (2) retrieving the selected content; (3) transcoding the retrieved content; (4) storing the transcoded content in an external file system; and (5) routing the transcoded content from the external file system to a remote destination.

According to a second aspect of the present invention, a method for transcoding content is provided. The method comprises the steps of: (1) selecting content and submitting a request for the selected content to a server, via a web browser; (2) a content Java Bean retrieving the selected content to the server from a content source; (3) a transcoding Java Bean automatically transcoding the retrieved content on the server; (4) storing the transcoded content in a file system external to the server; and (5) a mobile Internet agent routing the stored content from the external file system to a remote device.

According to a third aspect of the present invention, a system for transcoding content is provided. The system comprises: (1) a retrieval system for retrieving selected content from a content source to a server based on a request for the selected content generated via an interface; (2) a transcoding system for transcoding the retrieved content on the server; (3) a testing system for testing the transcoded content; and (4) a storage system for storing the tested content in a file system external to the server, wherein the stored content is routed from the file system to a remote destination by a mobile Internet agent.

According to a fourth aspect of the present invention, a program product stored on a recordable medium for transcoding content is provided. When executed, the program product comprises: (1) program code for retrieving selected content from a content source to a server based on a request for the selected content generated via an interface; (2) program code for transcoding the retrieved content on the server; (3) program code for testing the transcoded content; and (4) program code for storing the tested content in a file system external to the server, wherein the stored content is routed from the file system to a remote destination by a mobile Internet agent.

Therefore, the present invention provides a method, system and program product for transcoding content.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a high level architectural diagram according to the present invention.

FIG. 2 depicts an exemplary form defined via a content editor interface according to the present invention.

FIG. 3 depicts a computer system having a content system, according to the present invention.

FIG. 4 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

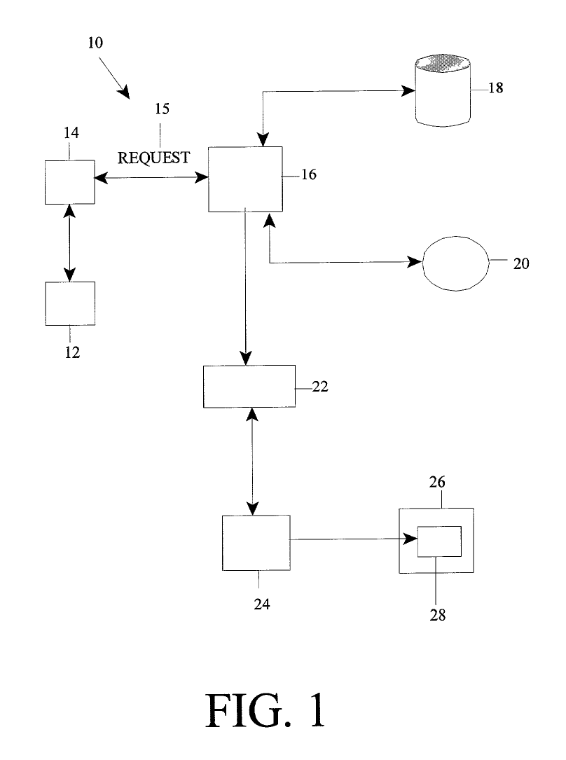

Referring now to FIG. 1, a high level architectural diagram 10 of the present invention is shown. In general, a content editor 12 will select content for transcoding and publication to mobile web users 26 through their remote devices 28. As used herein, content in intended to mean legacy content or any type of existing content. Moreover, as used herein, remote device is intended to mean any wireless electronic device capable of Internet access such as a personal digital assistant, cellular phone, etc.

As indicated above, remote devices 28 generally rely upon a mobile Internet service provider 24 such as AdvantGo® for their Internet service. However, transmission of content to such remote devices 28 often requires transcoding of the content from a first format to a second format useable by the remote device 28 (as well as the mobile Internet service provider 24). For example, content posted on a website 20 may contain images that must be compressed or clipped for display on remote device 28. Under previous systems, transcoding content into a format used by remote device 28 was a performed manually by technical editors. Such a process is both time-consuming and costly. The present invention provides automatic transcoding of content into a format used by remote device 28.

Under the present invention, content editor 12 selects content using content editor interface 14. In a typical embodiment, content editor interface 14 is a web browser that displays a form for content editor 12 to complete. In completing the form, content editor 12 will select content and, optionally, a schedule for retrieving, transcoding and storing the selected content. To select the content, content editor 12 can designate a content identifier for content stored in content sources 18 and 20. For example, content editor 12 can designate a unique identification (e.g., serial number) for content stored in a database 18, or a uniform resource locator (URL) for content posted on a world wide website 20. In either event, once specific content has been selected, a request 15 containing the selected content (and any defined schedule) will be transmitted to server 16. Under the present invention, server 16 is typically a Java-enabled web/application server that will retrieve and transcode the selected content. Specifically, once server 16 receives the request, the selected content contained therein will be retrieved from the pertinent content source(s) 18 and/or 20.

After retrieval, the content will be automatically transcoded on server 16. As indicated above, this generally involves automatically transcoding from a format such as HTML to a format (e.g., a simpler HTML format) used by remote device 28 (as well as mobile Internet service provider 24). Once transcoded, the content can be optionally tested to ensure that it will be readable by remote device 28. Testing could comprise a software-based simulation of the content being delivered to remote device 28. After testing, if performed, the transcoded content will be stored in an external file system 22. Specifically, the transcoded content will be “exported” to a file system that is external (i.e., outside the firewall) to server 16 and the associated web-site infrastructure. Once stored, mobile Internet service provider 24 can route the stored content from file system 22 to remote device user 26 via remote device 28. The transcoded content is typically stored external to server 16 because many mobile Internet service providers are configured to automatically retrieve transcoded content from file system 22 on a scheduled basis.

In a typical embodiment, content editor interface 14 is a web browser operated on a computer system that is remote from server 16. However, it should be understood that alternative implementations exist. For example content editor interface 14 could be an interface residing within server 16, which user 12 can directly access.

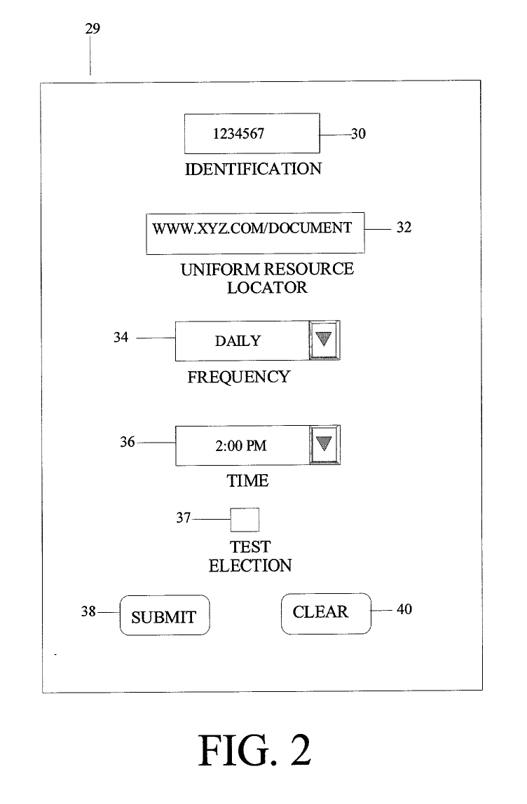

Referring now to FIG. 2, an exemplary form 29 completed via content editor interface 14 is shown. As depicted, form 29 includes identification field 30 and URL field 32. Identification field 30 allows content editor 12 to select content by designating a unique identification pertaining to content stored in database content source 18 or the like. URL field 32 allows content editor 12 to select content according to the web page content source 20 on which the content is posted. To this extent, it should be understood that the present invention is capable of obtaining and transcoding content from content sources 18 and 20 external to server 16.

As further shown in FIG. 2, content editor 12 could also define a schedule for retrieving, transcoding and storing content. For example, if mobile Internet service provider 24 routes content from file system 22 to remote device 28 every day at 2:30 PM, content editor 12 could designate that the content will be retrieved from content sources, transcoded and then stored in file system 22 daily at 2:00 PM. This capability is provided by frequency dialog 34 and time dialog 36, respectively. The option to test the content once transcoded can be designated via test election box 37. Once form 29 has been defined, content editor 12 can submit form 29 as a request 15 to server 16 using submit button 38. Alternatively, content editor 12 could clear form 29 using clear button 40.

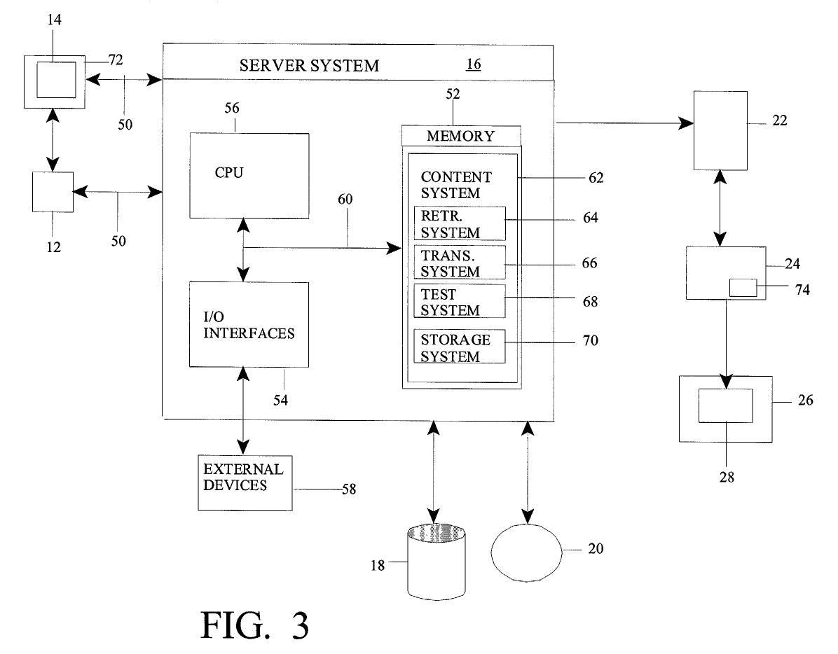

Referring now to FIG. 3, a computerized implementation of the present invention is shown in detail. Similar to FIG. 1, content editor 12 utilizes content editor interface 14 to select content. Once selected content is retrieved from content source(s) 18 and/or 20, it will be automatically transcoded and stored in external file system 22 for routing to remote device 28 by mobile Internet service provider 24.

As depicted, server 16 generally comprises memory 52, input/output (I/O) interfaces 54, a central processing unit (CPU) 56, external devices/resources 58 and bus 60. Memory 52 may comprise any known type of data storage and/or transmission media, including magnetic media, optical media, random access memory (RAM), read-only memory (ROM), a data cache, a data object, etc. Moreover, memory 52 may reside at a single physical location, comprising one or more types of data storage, or be distributed across a plurality of physical systems in various forms. CPU 56 may likewise comprise a single processing unit, or be distributed across one or more processing units in one or more locations, e.g., on a client and server.

I/O interfaces 54 may comprise any system for exchanging information from an external source. External devices 58 may comprise any known type of external device, including speakers, a CRT, LED screen, hand-held device, keyboard, mouse, voice recognition system, speech output system, printer, monitor, facsimile, pager, etc. Bus 60 provides a communication link between each of the components in the server 16 and likewise may comprise any known type of transmission link, including electrical, optical, wireless, etc. In addition, although not shown, additional components, such as cache memory, communication systems, system software, etc., may be incorporated into server 16.

Database content source 18 may provide storage for content to be transcoded under the present invention. As such, database 18 may include one or more storage devices, such as a magnetic disk drive or an optical disk drive. In another embodiment database 18 includes data distributed across, for example, a local area network (LAN), wide area network (WAN) or a storage area network (SAN) (not shown). Database 18 may also be configured in such a way that one of ordinary skill in the art may interpret it to include one or more storage devices.

As depicted, content editor 12 can communicate with server 16 via content editor interface 14 operated from computer system 72 that is remote from server 16. Alternatively, content editor 12 can communicate directly with server 16. In such a case, an interface would be provided within server 16. Communications links 50 are shown to illustrate the possible communications alternatives between content editor 12 and server 16. As such, communications links 50 can include a direct hardwired connection (e.g., serial port), or an addressable connection such as a remote system in a client-server environment. In the case of the latter, the client 72 and server 16 may be connected via the Internet, wide area networks (WAN), local area networks (LAN) or other private networks. The server 16 and client 72 may utilize conventional token ring connectivity, Ethernet, or other conventional communications standards. Where the client 72 is connected to the server 16 via the Internet, connectivity could be provided by conventional TCP/IP sockets-based protocol. In this instance, the client 72 would utilize an Internet service provider outside the system to establish connectivity to the server 16.

It is understood that the present invention can be realized in hardware, software, or a combination of hardware and software. Moreover, server 16 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein—is suited. A typical combination of hardware and software could be a general purpose (computer) system with a computer program that, when loaded and executed, controls server 16 such that it carries out the methods described herein. Alternatively, a specific use (computer) system, containing specialized hardware for carrying out one or more of the functional tasks of the invention could be utilized. The present invention can also be embedded in a computer program product, which comprises all the features enabling the implementation of the methods described herein, and which—when loaded in a (computer) system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Shown in memory 52 is content system 62. As depicted, content system 52 includes retrieval system 64, transcoding system 66, testing system 68 and storage system 70. In a typical embodiment, content system 62 is implemented as a Java-based system for platform (i.e., operating system) independence. Accordingly, content system 62 typically includes one or more serlvets and Java Beans that perform the functions described herein. As used herein, the term servlet is intended to mean a program running within a Java-enabled web server (i.e., server 16). Moreover, the term Java Bean is intended to mean a reusable component used to create Java programs.

As indicated above, content editor 12 will use content editor interface 14 to select content and optionally designate a schedule. The selected content is then “bundled” as a request, which is transmitted to server 16. Once received by server, retrieval system 64 will interpret the request and access content sources 18 and/or 20. Specifically, a servlet in server 16 will contact a content Java Bean (i.e., in retrieval system 64) to retrieve the selected content from the appropriate content source 18 and/or 20. For example, if the request included a unique identification corresponding to content stored in database 18, retrieval system 64 (i.e., the content Java Bean of retrieval system 64) would access database 18 to retrieve the selected content to server 16. Similarly, if content editor 12 selected content designating a URL, retrieval system 64 would access the corresponding web page and retrieve the content.

Once retrieved, the content is automatically transcoded by transcoding system 66. In particular, a servlet in server 16 would contact a transcoding Java Bean within transcoding system 66 to transcode the content from its original format (e.g., HTML) to a format used by remote device 28. As indicated above, this could involve automatic compression of content, translation of numbers, letter and/or symbols, etc. Once the content has been transcoded, the transcoded content could be tested via testing system 68 (e.g., if testing box 37 of form 29 in FIG. 2 was selected). In a typical embodiment, testing system 68 includes a program for simulating a remote device 28. Thus, when the transcoded content is loaded into the simulated device, it can be determined whether any errors were made in transcoding the content.

Ultimately, the transcoded content (whether tested or not) will be stored in file system 22 by storage system 70. File system 22 can be any system such as a database capable of storing the content. Moreover, file system 22 is typically external to server 16. That is, file system 22 is typically outside of server's 16 firewall. After content is stored, the process can be automatically repeated if content editor 12 designated a schedule. For example, as shown in FIG. 2, the selected content can be retrieved from content sources 18 and/or 20, automatically transcoded, optionally tested and stored in file system 24 every day at 2:00 PM. In any event, once the transcoded content is stored in file system 22, a mobile Internet agent 74 of mobile Internet service provider 24 will route the stored content from file system 22 to user 26 via remote device 28. As used herein, a mobile Internet agent is a program that performs a service such routing content to remote device 28. As indicated above, this could be performed on a scheduled basis.

Accordingly, the present invention provides a system whereby an editor 12 can select content from a remote location. The selected content can be retrieved, automatically transcoded (and optionally tested), and then stored in an external file system 22 for routing to remote device 28 by mobile Internet service provider 24. It should be understood that as described herein, the present invention is typically implemented using the Java programming language. This allows the present invention to be platform (i.e., operating system) independent. However, it should be understood that in the event platform independence is not required, the present invention could be implemented in another programming language such as C++.

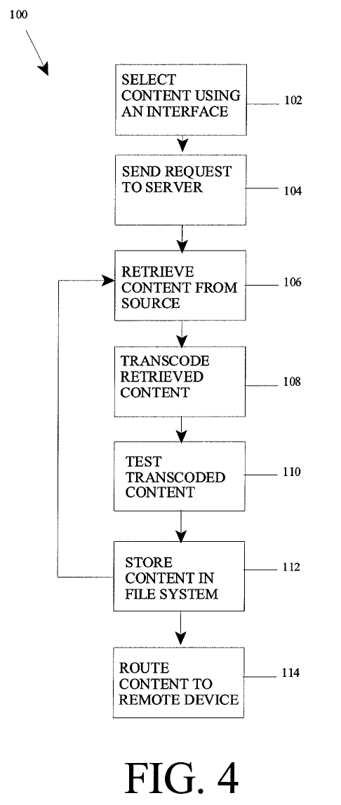

Referring now to FIG. 4, a method flow diagram 100 according to the present invention is shown. A shown, first step 102 is to select content using an interface. Once selected, a request containing the selection will be sent to the server 16 in step 104. The server 16 will then retrieve the selected content from the content source 18 and/or 20 in step 106. Once retrieved, the content will be automatically transcoded 108. After transcoding, the content could be optionally tested for accuracy 110. Whether tested or not, the transcoded content will then be stored in file system 22 outside the server 16 firewall in step 112. The steps of content retrieval, transcoding testing and storage can be repeated according to any designated schedule. In any event, the mobile Internet service provider 24 will route the stored content from the file system 24 to the remote device 28 in step 114.

Listed below is an example of the code use to implement the present invention as described herein:

```
package com.ibm.avantgo.servlet;
import java.io.*;
import javax.servlet.*;
import javax.servlet.http.*;
import com.ibm.transform.bean.*;
import com.ibm.avantgo.utilities.*;
public class TransServlet extends HttpServlet
{
  HtmlReducerBean htmlReducerBean;
  HtmlHandlerBean htmlHandlerBean;
  final String HTMLTYPE = “text/html”;
  final String PALMUSERAGENT = “Mozilla/3.0 (compatible; HandHTTP 1.1”;
  private static Properties props = new Properties();
  private static String propFileName = “/avantgo.properties”;
  private static String FAQOutputDir;
  private static String installPath;
  private static long delayTime = 86400000L;;
  private static String remoteFAQFile;
  /**
  * Called when servlet is first loaded
  * @param config information for this servlet
  *
  */
  public void init (ServletConfig config) {
```

try{
super.init(config);
//Initialize variables by reading values from property file
loadProperties();
//Initialize transcoder bean - HtmlReducerBean from WebSphere

Transcoding Publisher

initializeBean();
// Here we spawn away a thread to handle the necessary cron job,

the cron job is part of the web application.

startThread(FAQOutputDir);
}
catch (Throwable theException)
{
// uncomment the following line when unexpected exceptions are

occuring to aid in debugging the problem

theException.printStackTrace();
}

}
// service(), doGet(), doPost() methods can be added here to perform
task
private void loadProperties() throws Exception {

props.load(getClass().getResourceAsStream(propFileName));
FAQOutputDir = props.getProperty(“FAQOutputDir”);
installPath = props.getProperty(“installPath”);
String delayMinutes = props.getProperty(“delayTime”);
delayTime = (new Integer(delayMinutes)).intValue() * 60 * 1000L;
remoteFAQFile = props.getProperty(“remoteFAQFile”);

}
private void initializeBean() throws Exception {

htmlReducerBean = new HtmlReducerBean();
htmlReducerBean.setInstallPath(installPath);
htmlReducerBean.setSystemDatabaseDirectory(“etc”);
htmlReducerBean.initialize();

}
private void startThread(String OutputDir) {

Thread rcpThread = new Thread(new RCPThread(delayTime,

FAQOutputDir, remoteFAQFile));

rcpThread.start();

}
}
package com.ibm.avantgo.utilities;
import java.io.*;
import java.util.*;
public class RCPTbread implements Runnable {

/**
* Delay time for changing avantgo FAQ
*/
public static long delay = 86400000L; // default value
public static long preDelay = 30000L;
public static long interDelay = 60000L;
String delCmd = “CMD /C del ”;
String rcpCmd= “CMD /C rcp ”;
String outputDir = “C:\\wireless\\output\\”; // default value
String remoteFF = developer:/www/transtest/24/faq.html”; //

default value

String fileName;
File file;
public RCPThread(long delayTime, String FAQOutputDir, String

remoteFAQFile)

{

super();
//Initialize variables
delay = delayTime;
outputDir = FAQOutputDir;
remoteFF = remoteFAQFile;

}
public void run()
{

try{

Thread.sleep(preDelay);
//Following code checks whether a FAQ file exists on the

local file system, if yes it will copy the file to the remote file
system, then delete the file

//This operation can be easily configured to happen, for

example once a day in the servlet property file

```
while (true) {
  for (int i=1; 1 <= 7; i++) {
  fileName = outputDir + “FAQ” + i + “.html”;
  file = new File(fileName);
  if (file.exists()) {
    Runtime.getRuntime().exec(rcpCmd +
```

fileName.substring(2) +“ ” + remoteFF);

```
    Thread.sleep(interDelay);
    Runtime.getRuntime().exec(delCmd + fileName);
  reak;
  }
}
Thread.sleep(delay);
}
```

} catch (Exception e) {
e.printStackTrace();
}

}
}

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, it should be appreciated that content system 62 of present invention has been depicted as having four separate subsystems for illustrative purposes only, and that other variations could be implemented.

1. A method for transcoding content, comprising the steps of:
selecting content using an interface;
retrieving the selected content;
transcoding the retrieved content;
storing the transcoded content in an external file system; and
routing the transcoded content from the external file system to a remote destination.

2. The method of claim 1, further comprising the step of testing the transcoded content, prior to the storing step.

3. The method of claim 1, wherein the selecting step comprises the step of designating a content identifier via a web browser.

4. The method of claim 1, wherein the selected content is retrieved to the server via a content Java Bean.

5. The method of claim 1, wherein the selected content is retrieved from a database.

6. The method of claim 1, wherein the selected content is retrieved from a web site.

7. The method of claim 1, wherein the retrieved content is transcoded via a transcoding Java Bean.

8. The method of claim 1, wherein the transcoded content is routed from the external file system to the remote destination via a mobile Internet agent.

9. The method of claim 8, wherein the remote destination is a wireless device.

10. A method for transcoding content, comprising the steps of:
selecting content and submitting a request for the selected content to a server, via a web browser;
a content Java Bean retrieving the selected content to the server from a content source;
a transcoding Java Bean automatically transcoding the retrieved content on the server;
storing the transcoded content in a file system external to the server; and
a mobile Internet agent routing the stored content from the external file system to a remote device.

11. The method of claim 10 further comprising testing the transcoded content, prior to the storing step.

12. The method of claim 10, wherein the storage source is external to the server.

13. The method of claim 12, wherein the external storage source is selected from the group consisting of a database and a web site.

14. The method of claim 10, wherein the selecting step comprises designating a content identifier via a web browser.

15. The method of claim 10, wherein the remote device is a hand-held device.

16. A system for transcoding content, comprising:
a retrieval system for retrieving selected content from a content source to a server based on a request for the selected content generated via an interface;
a transcoding system for transcoding the retrieved content on the server;
a testing system for testing the transcoded content; and
a storage system for storing the tested content in a file system external to the server, wherein the stored content is routed from the file system to a remote destination by a mobile Internet agent.

17. The system of claim 16, wherein the interface is a web browser residing on a client.

18. The system of claim 16, wherein the selected content is retrieved from the content source based on a predefined schedule.

19. The system of claim 16, wherein the content source is external to the server.

20. The system of claim 16, wherein the transcoding system transcodes the retrieved content from a first format to a second format used by the remote destination.

21. The system of claim 16, wherein the retrieval system comprises a content Java Bean for retrieving the selected content, and wherein the transcoding system comprises a transcoding Java Bean for transcoding the retrieved content.

22. A program product stored on a recordable medium for transcoding content, which when executed, comprises:
program code for retrieving selected content from a content source to a server based on a request for the selected content generated via an interface;
program code for transcoding the retrieved content on the server;
program code for testing the transcoded content; and
program code for storing the tested content in a file system external to the server, wherein the stored content is routed from the file system to a remote destination by a mobile Internet agent.

23. The program product of claim 22, wherein the interface is a web browser residing on a client.

24. The program product of claim 22, wherein the selected content is retrieved from the content source based on a predefined schedule.

25. The program product of claim 22, wherein the content source is external to the server.

26. The program product of claim 22, wherein the retrieved content is transcoded from a first format to a second format used by the remote destination.

27. The system of claim 22, wherein the program code for retrieving the selected content comprises a content Java Bean for retrieving the selected content, and wherein the program code for transcoding the retrieved content comprises a transcoding Java Bean for transcoding the retrieved content.
